(19) United States
(12) Patent Application Publication
(10) Pub. No.: US 2006/0243703 A1
(43) Pub. Date: Nov. 2, 2006

(54) Outdoor bushing comprising an integrated disconnecting switch

(75) Inventor: Manfred Meinherz, Berlin (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 10/558,745

(22) PCT Filed: May 3, 2004
(86) PCT No.: PCT/DE04/00980

§ 371 Date: Dec. 1, 2005

(30) Foreign Application Priority Data
Jun. 2, 2003 (DE) 103256857

(51) Int. Cl. H01H 33/66

(52) U.S. Cl. 218/134; 218/139

(57) ABSTRACT

The invention relates to a outdoor bushing for connecting an air-insulated high-voltage conductor to components in a grounded housing enclosed by gas, comprising fixing elements for mounting the outdoor bushing on the housing in a gas-tight manner and an open-air connection for connecting the high voltage conductor, said connection being attached to the fixing elements in a gas-tight manner by means of a hollow insulator. In the latter, electroconductive connection elements extend between the open-air connection and an internal connection for connecting the components. The aim of the invention is to provide an outdoor bushing of this type, which offers other functions in addition to the connection of an air-insulated high-voltage conductor to the protective-gas insulated atmosphere of a grounded housing, by means of its connection elements. To achieve this, said connection elements comprise a disconnecting switch.

This application is a national stage of PCT/DE2004/000980 which was published on Dec. 16, 2004 and which claims the benefit of priority to German Application No. 103 25 685.7 filed Jun. 2, 2003.

### TECHNICAL FIELD OF THE INVENTION

The invention relates to an outdoor bushing for the purpose of connecting an air-insulated high-voltage conductor to components in a gas-encapsulated housing at ground potential having fixing means for the purpose of fitting the outdoor bushing to the housing in a gas-tight manner and an outdoor connection, which is connected in a gas-tight manner to the fixing means via a hollow insulator, for the purpose of connecting the high-voltage conductor, electrically conductive connecting means extending in the insulator between the outdoor connection and an inner connection provided for the purpose of connecting the components.

### BACKGROUND OF THE INVENTION

Such an outdoor bushing has already been disclosed in DE 100 32 656 A1. The outdoor bushing disclosed therein has a high-voltage connection for the purpose of receiving an air-insulated high-voltage cable and fixing means for the purpose of mounting the outdoor bushing in a gas-tight manner on a grounded metallic housing. A hollow-cylindrical insulator is provided between the fixing means and the high-voltage connection, and an electrical conductor extends in the longitudinal direction of said hollow-cylindrical insulator. The previously known outdoor bushing merely serves the purpose of connecting an air-insulated high-voltage conductor to components, which are arranged in a grounded housing which, for the purpose of reducing its physical volume, is filled with an insulating gas having a high dielectric strength. EP 1 207 601 A2 has disclosed a gas-encapsulated switchgear assembly having switches which are fixed on a metallic housing. The switches have a hollow-cylindrical insulator which is provided for the purpose of accommodating switching contacts. The metallic housing is at a high-voltage potential during operation and, for this reason, is mounted on an insulating mounting frame. A complex transmission mechanism is provided for the purpose of transmitting the drive movement from one drive motor, which is at ground potential, to the switches, which are at a high-voltage potential.

The German utility model DE 296 14 799 U1 has disclosed a switchgear assembly which has a housing mounted on a mounting frame for the purpose of encapsulating a power breaker. In order to avoid excessively large distances between the power breaker, which is at a high-voltage potential, and the housing, which is at ground potential, the housing is filled with sulfur hexafluoride. The sulfur hexafluoride also acts as a quenching gas for the purpose of quenching an arc drawn when the contacts of the power breaker are isolated. Furthermore, connecting stubs, which are inclined away from one another, are provided on the housing, and outdoor bushings are fixed to said connecting stubs and are adjusted for the purpose of connecting high-voltage conductors. In order also to be able to reliably maintain high voltage differences over longer periods of time, switch disconnectors are provided in the connecting stubs, and the contacts of these switch disconnectors are isolated from one another so that no current flows after the current has been interrupted by the power breaker.

### SUMMARY OF THE INVENTION

The object of the invention is to provide an outdoor bushing of the type mentioned initially which provides additional functions in addition to merely connecting a high-voltage conductor from an air insulation to the protective gas insulation of a grounded housing via its connecting means. The invention achieves this object by the connecting means having a switch disconnector.

Owing to the arrangement of a switch disconnector in the insulator, the outdoor bushing can also take on isolating functions in addition to merely changing over from the air-insulated high-voltage conductor to gas-encapsulated components within a grounded housing. According to the invention, there is no need to provide a switch disconnector in the housing. This increases the degree of compactness of the housing. The dimensions of the outdoor bushing according to the invention are matched to the voltage drop during operation between the fixing means, at ground potential, and the high-voltage connection and thus correspond to the dimensions of conventional outdoor bushings. The distances between the switch disconnector and the inner wall of the insulator can be designed to be as low as desired without there being a risk of partial discharges or voltage flashovers. According to the invention, it is also possible to design the housing, which is at ground potential, independently of the type or number of switch disconnectors. For example, the housing for switchgear assemblies which do not have any switch disconnectors can be produced such that it has the same dimensions as a housing which is envisaged for a switchgear assembly having, for example, two switch disconnectors.

The insulator is expediently produced from porcelain or an insulating composite material, for example a textile-fiber tube having silicone shields.

The insulator is advantageously hollow-cylindrical.

The outdoor connection is expediently arranged at one end on the hollow-cylindrical insulator and has a closure cap which is connected in a gas-tight manner to the insulator by means of expedient joining means, for example by means of an adhesive. The switch disconnector is expediently arranged centrally in the insulator such that equal distances are provided on all sides between the insulator and the switch disconnector. The fixing means are expediently arranged at that end of the insulator which faces away from the outdoor connection and are likewise connected to the insulator by joining means, i.e. adhesives, cements or the like.

Insulating holding means are advantageously provided for the purpose of holding the switch disconnector in the insulator. The holding means hold the switch disconnector in the insulator and are mechanically connected to the fixing means, which are at ground potential during operation. In order to maintain the voltage drop between the switch disconnector and the fixing means, the holding means are produced from an insulating material such as cast resin, a fiber-reinforced plastic or another expedient ceramic.

In accordance with one development which is advantageous in this regard, the holding means are gas-permeable. Only one gas chamber is thus formed once the outdoor bushing has been mounted onto the gas-tight housing, said gas chamber comprising the interior of the metallic housing and the cavity, communicating with said housing, of the outdoor bushing. In order to monitor the leakproofness after mounting, only one leakproofing test is therefore required. Suitable gas-permeable holding means are, for example, contactors which are connected, on the one hand, to the fixing means and, on the other hand, to a component which is fixedly connected to the switch disconnector. Owing to the contactors, the switch disconnector is supported on the fixing means.

As a deviation from this, the holding means are gas-tight. In this embodiment of the invention, a separate gas chamber is formed by the outdoor bushing after mounting as well, it being possible for this gas chamber to be filled with a separate gas which is independent of the gas of the housing. It is thus possible, for example, for the gas of the outdoor bushing to be different from that of the housing. A gas-impermeable bulkhead bushing, for example, is suitable as the gas-tight holding means.

The switch disconnector advantageously has contact pieces whose ends lie opposite one another, it being possible for the switch disconnector to be moved from a contact position, which allows current to flow, to an isolated position, in which an electrically isolating gap is provided between the contact pieces, by means of introducing a linear movement. In accordance with this expedient development of the invention, the switch disconnector is matched as much as possible in terms of its design to a homogeneous cylindrical conductor extending in an axial direction, with the result that reference may be made to experiences with previously known high-voltage bushings which do not have a switch disconnector in their interior. This applies both to its dimensions and to the material used.

The switch disconnector expediently has a stationary female contact and a sliding contact which is supported firmly on the fixing means via a hollow connecting rod, a switching pin, whose movement is guided by the sliding contact, being provided for the purpose of making contact with the female contact, which is driven via drive means arranged in the connecting conductor. The drive means arranged in the hollow connecting conductor are encapsulated by said connecting conductor such that voltage peaks at corners and edges of the drive means are even avoided during a drive movement, and thus partial discharges are avoided. Furthermore, the switch disconnector has two stationary contact pieces, which can be held in a simple manner. It is thus no longer necessary to mount a contact piece on the fixing means in a complex manner such that it can move.

In one further expedient refinement of the invention, at least one drive shaft is provided for the purpose of introducing a drive movement into the switch disconnector. In this case, each drive shaft is mounted in the fixing means by means of an expedient rotary bearing, expedient sealing means ensuring gas-tight bushing of the drive shaft through the outer wall of the fixing means. In accordance with this embodiment of the invention, the drive movement can be introduced via a rotary movement into the interior of the outdoor bushing, which interior is gas-insulated during operation.

In accordance with one expedient development, an isolating rocker made from an insulating material is provided for the purpose of introducing a drive movement. The isolating rocker is, for example, mechanically connected to a coupling rod, which forms a switching pin at its end which is remote from the isolating rocker, said switching pin producing the conductive connection between the contact pieces of the switch disconnector in a contact position of said switch disconnector. The isolating rocker converts a rotary movement, as a drive movement, into a linear movement and introduces a translational movement into the switch disconnector, in which case this switch disconnector is correspondingly designed as a push switch.

A grounding switch is advantageously provided. The grounding switch is connected to the fixing means and has a switching pin which makes contact, in a grounding position, with a conductor, which is electrically connected to the switch disconnector. In order to drive the grounding switch, a grounding shaft is expediently provided which is mounted in the fixing means. In this case, the grounding shaft is driven, for example, by motor or by hand.

In accordance with one preferred exemplary embodiment, the fixing means have an intermediate housing which delimits an intermediate cavity extending a cavity of the insulator. The intermediate housing is connected, for example, to connecting means which are connected to the insulator. In this case, the connecting means are a flange connection which is adhesively bonded to the insulator. The intermediate housing is fixedly connected to the connecting means by means of a screw connection, for example. As a deviation from this, the intermediate housing is integrally formed on the connecting means. In this case the entire fixing means are produced from a metallic material, such as aluminum. The intermediate housing therefore provides, for example, the mechanical robustness required for fixing a grounding switch or for holding an isolating rocker.

The intermediate housing expediently has an angled housing having a curved profile. A curved profile is particularly advantageous when two or more outdoor bushings are fixed to the housing in order to provide the required distance between the outdoor connections of these outdoor bushings.

The outdoor bushing advantageously has a current transformer which is at ground potential on the secondary side. In this case, the current transformer is arranged in the region of the fixing means such that the ground potential required on the secondary side is always provided during operation of the outdoor bushing. Further advantages result if the current transformer is a current adapter which can also be detached from a fixedly mounted outdoor bushing in a simple manner, namely by simply removing it from the insulator without opening the gas chamber.

The fixing means are expediently electrically connected to field control elements for the purpose of avoiding partial discharges.

A display element may also be advantageous for the purpose of displaying the position of the switch disconnector.

At least one drive unit, which is supported on the fixing means, is advantageously provided for the purpose of producing a drive movement. It is thus possible for the outdoor bushing according to the invention to be produced as a ready-to-operate individual component irrespective of the later use.

Further expedient refinements and advantages of the invention are the subject matter of the description below and exemplary embodiments of the invention with reference to the figures of the drawing, in which identical references refer to components having the same function and

### BRIEF DESCRIPTION OF THE DRAWINGS

FIG. 1 shows a partially sectioned side view of one exemplary embodiment of the outdoor bushing according to the invention,

FIG. 2 shows a sectioned side view of a further exemplary embodiment of the outdoor bushing according to the invention,

FIG. 3 shows a sectioned side view of a further exemplary embodiment of the outdoor bushing according to the invention, and

FIG. 4 shows a sectioned side view of a further exemplary embodiment of the outdoor bushing according to the invention.

### DETAILED DESCRIPTION OF THE INVENTION

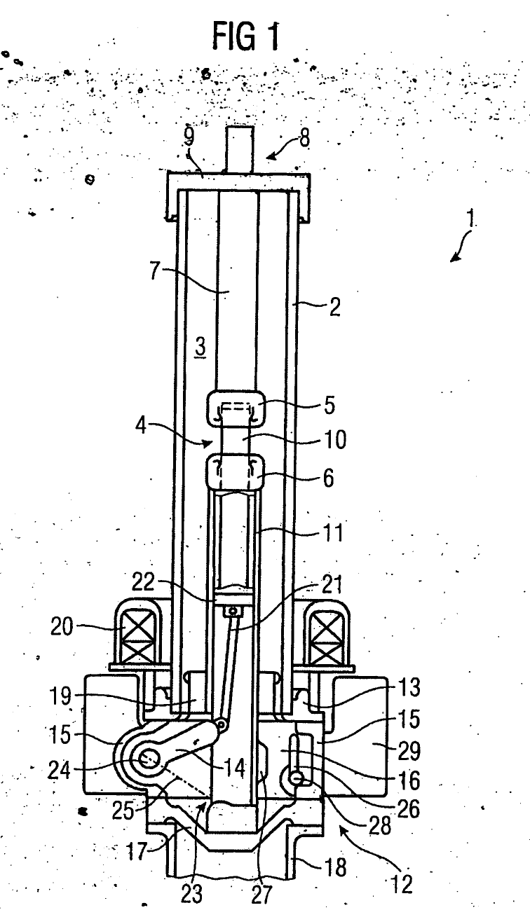

FIG. 1 shows one exemplary embodiment of the outdoor bushing 1 according to the invention, which has a hollow-cylindrical insulator 2 having a cavity 3 for the purpose of accommodating a switch disconnector 4. The switch disconnector 4 comprises a stationary female contact 5 and a likewise stationary sliding contact 6. The female contact 5 is connected to an outdoor connection 8 via a contact rod 7. The outdoor connection 8 is arranged at one end on the insulator 2 and has a closure cap 9 which is connected to the insulator 2 in a gas-tight manner by means of adhesive and closes the cavity 3 of the insulator 4 in a gas-tight manner.

A switching pin 10 is guided such that it can move in the sliding contact 6, the sliding contact 6 being electrically connected to a plug contact (not illustrated in the figures) as an inner connection via a hollow connecting conductor 11, with the result that, once the switching pin 10 has been inserted into the female contact 5, as shown in FIG. 1, a conductive connection is produced between the outdoor connection 8 and the plug contact. In other words, the contact rod 7, the female contact 5, the switching pin 10, the sliding contact 6 and the connecting conductor 11 form connecting means which conductively connect the outdoor connection 8 to the plug contact in a contact position in which the switching pin 10 has been inserted into the female contact 5.

At that end of the insulator 2 which is remote from the outdoor connection 8, fixing means are provided which, in the exemplary embodiment shown, comprise an intermediate housing 12 and a flange connection 13 as the connecting means, the insulator 2 being fixedly adhesively bonded to the flange connection 13. The fixing means produced from aluminum are tubular and have a straight profile in the direction of the longitudinal extent of the insulator 2. The intermediate housing 12 is fixedly screwed to the flange connection 13.

In order to introduce a switching movement into the switching pin 10, an electrically nonconductive isolating rocker 14, which is arranged in the intermediate housing. 12, is provided, lateral holding caps 15 being provided for the purpose of closing an intermediate cavity 16, which is delimited by the intermediate housing 12, in a gas-tight manner. The intermediate cavity 16 is part of the cavity 3.

In order to hold the sliding contact 6 above the connecting conductor 11 in the high-voltage outdoor bushing 1, a gas-tight bulkhead bushing 17 is provided as the holder, which is fixedly mounted between the intermediate housing 12 and a grounded connecting stub 18 of a housing (not illustrated). In this case, the connecting rod 11 protrudes centrally through the bulkhead bushing 17, sealing means (which are not shown in FIG. 1) ensuring a gas-tight connection of the connecting rod 11 by means of the bulkhead bushing 17. In this manner, a separate and gas-tight gas chamber is formed by the cavity 3 and can be filled with a quenching or insulating gas, such as sulfur hexafluoride.

The bulkhead bushing 17 is produced from an insulating material, such as cast resin.

The outdoor connection 8 is provided for the purpose of connecting an air-insulated high-voltage line, whereas the connecting stub 18 of the housing is at ground potential. Field control elements 19 are provided in order to avoid voltage peaks owing to high electrical field strengths at corners and edges of the fixing means (12, 13). In addition, a conventional current adapter 20 can be seen which is arranged concentrically with respect to the tubular insulator 2. In this case, the current adapter is connected on the secondary side to the fixing means such that the required ground potential for the current adapter 20 is provided during operation.

In order to transmit the drive movement from the isolating rocker 14 to the switching pin 10, a coupling rod 21 is provided which is articulated on the isolating rocker 14 and is connected fixedly to the switching pin 10 at its end which is remote from the isolating rocker 14 via a switching pin guide 22. It can be seen that the switching pin 10 and the switching pin guide 22 are arranged within the hollow connecting conductor 11 which, for this reason, acts as a guide means for the switching pin 10 and the drive means 20, 21, 22 in addition to a purely electrical connection.

Furthermore,the encapsulation of the connecting conductor avoids partial discharges at corners and edges of the drive means 20, 21, 22.

In order to make it possible to move the isolating rocker 14, the connecting conductor 11 has a lateral opening 23 which is opposite the isolating rocker 14.

The isolating rocker 14 is also connected to a drive shaft 24 such that it is fixed against rotation, said drive shaft 24 being passed out of the intermediate housing 13 via an expedient rotary bearing equipped with sealing means. By rotating the drive shaft 24, the isolating rocker 14 is moved to an isolated position 25 (indicated in FIG. 1), in which the switching pin 10 is moved out of the female contact such that an isolating gap is provided between the female contact 5 and the sliding contact 6.

In addition, a grounding switch 26 can be seen on the holding cap 15 and opposite the isolating rocker 14, said grounding switch 26 being provided for the purpose of grounding the switch disconnector 4 once the switch disconnector 4 has been opened. For this purpose, the grounding switch 26 has a conductive connection between a grounding contact 27, which is at the potential of the connecting conductor 11, and the metallic intermediate housing 12, which is at ground potential. In order to drive the grounding switch 26, a grounding shaft 28 is provided which is passed out of the intermediate housing 12.

Also shown is a drive gearbox 29, which is fixed to the intermediate housing 12, for the purpose of producing a drive movement for the drive shaft 24 and for the grounding shaft 27.

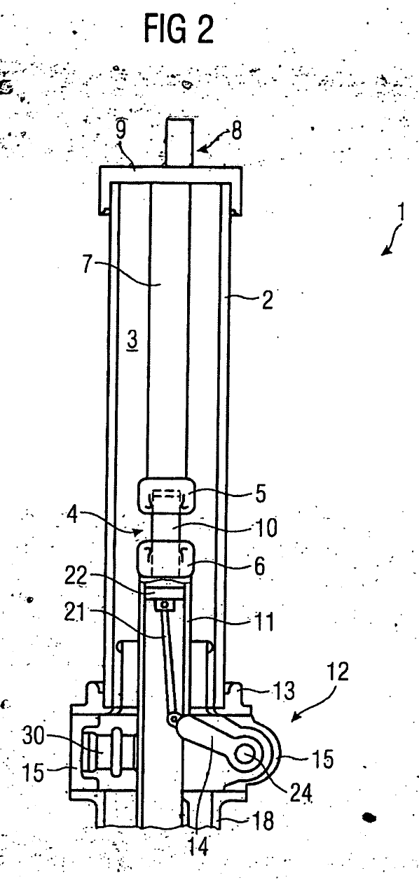

FIG. 2 shows a further exemplary embodiment of the outdoor bushing 1 according to the invention, which, in contrast to the exemplary embodiment shown in FIG. 1, does not have a grounding switch 25 in the intermediate housing 12. Instead of being held by a gas-tight bulkhead bushing, the connecting conductor 11 and thus the sliding contact 6 are held by means of a contactor 30, which is produced from an insulating material such as cast resin, on the intermediate housing 12. For this purpose, the contactor 30 is supported on the holding cap 15 and is fixedly connected to the connecting rod 11. The contactor 30 forms a gas-permeable holder, with the result that the cavity 3 enlarged by the intermediate cavity 16 communicates with the interior volume of the housing 18.

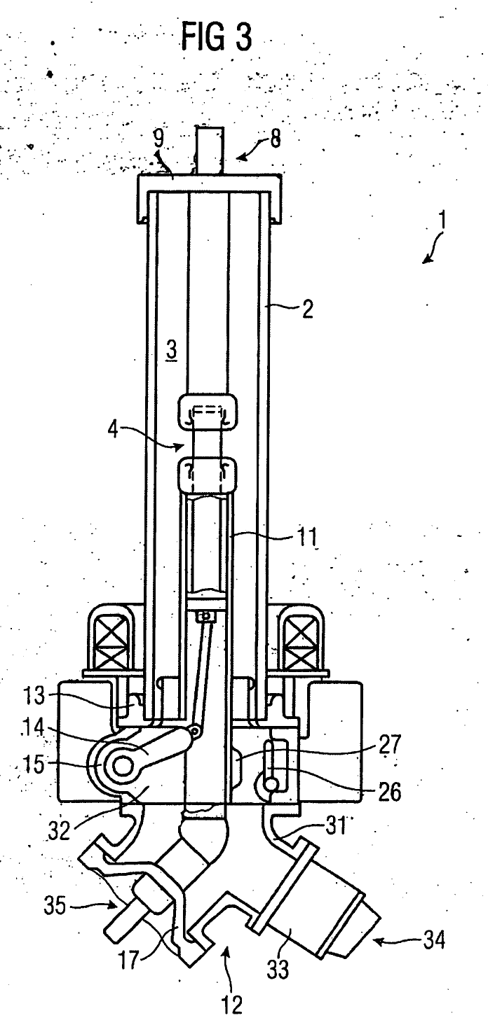

FIG. 3 shows a further exemplary embodiment of the outdoor bushing 1 according to the invention, in the case of which the intermediate housing 12 comprises a curved angled housing 31 and a gear mechanism housing 32. The gear mechanism housing 32 is envisaged for accommodating the isolating rocker 14 and the grounding switch 26, while a filter unit 33 with a rupture diaphragm 34 is provided in the angled housing 31. In addition, FIG. 3 shows a plug contact 35 as an inner connection. The curved profile of the intermediate housing 12 is advantageous when two or more outdoor bushings 1 are fixed to one housing, the distance required to avoid voltage flashovers being provided with an air atmosphere between the outdoor connections 8 of said outdoor bushings 1.

In the exemplary embodiment illustrated in FIG. 3, the gear mechanism housing 32 and the angled housing 31 of the intermediate housing 12 are formed as separate components. In addition, a gas-tight bulkhead bushing 17 is used for holding the switch disconnector 4.

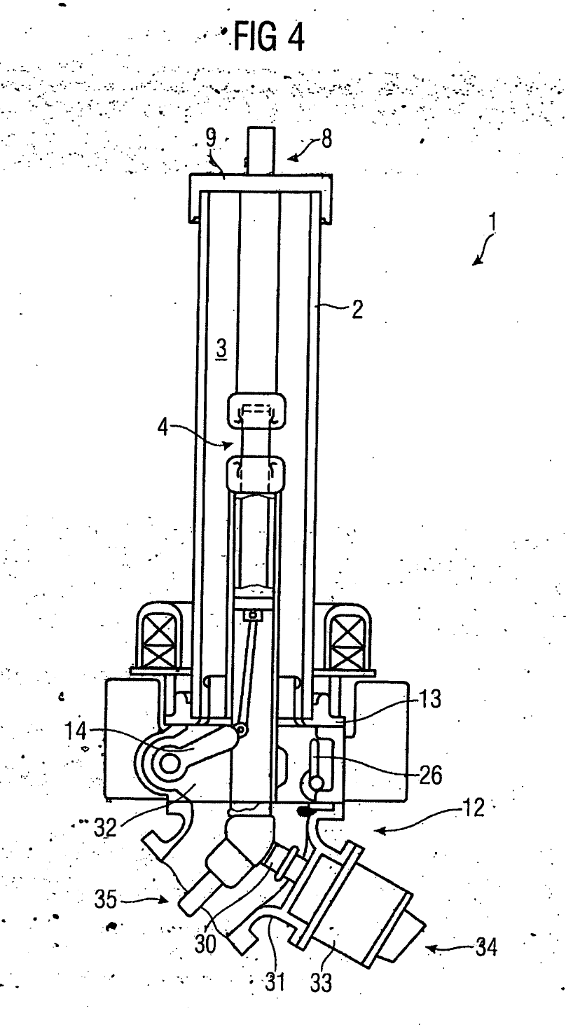

FIG. 4 shows one exemplary embodiment of the outdoor bushing 1 according to the invention, in which the connecting means 13, the angled housing 31 and the gear mechanism housing 32 and thus the intermediate housing 12 are of integral design. In this case, a gas-permeable contactor 30 is used for holding the switch disconnector 4.

1. An outdoor bushing (1) for the purpose of connecting an air-insulated high-voltage conductor to components in a gas-encapsulated housing (18) at ground potential having fixing means (12, 13) for the purpose of fitting the outdoor bushing (1) to the housing (18) in a gas-tight manner and an outdoor connection (8), which is connected in a gas-tight manner to the fixing means (12, 13) via a hollow insulator (2), for the purpose of connecting the high-voltage conductor, electrically conductive connecting means (4, 7, 11) extending in the insulator (2) between the outdoor connection (8) and an inner connection (35) provided for the purpose of connecting the components,
wherein
the connecting means have a switch disconnector (4).

2. The outdoor bushing (1) as claimed in claim 1,
characterized by
insulating holding means (17, 30) for the purpose of supporting the switch disconnector (4) on the fixing means (12, 13).

3. The outdoor bushing (1) as claimed in claim 2,
wherein
the holding means (30) are gas-permeable.

4. The outdoor bushing (1) as claimed in claim 2,
wherein
the holding means (17) are gas-tight.

5. The outdoor bushing (1) as claimed claim 1, wherein the switch disconnector (4) has contact pieces (5, 6) whose ends lie opposite one another, it being possible for the switch disconnector (4) to be moved from a contact position, which allows current to flow, to an isolated position, in which an electrically isolating gap is provided between the contact pieces (5, 6), by means of introducing a linear movement.

6. The outdoor bushing (1) as claimed in claim 5,
wherein the switch disconnector (4) has a stationary female contact (5) and a sliding contact (6) which is supported firmly on the fixing means (12, 13) via a hollow connecting rod (11), a switching pin (10), whose movement is guided by the sliding contact (6), being provided for the purpose of making contact with the female contact (5), which is driven via drive means arranged in the connecting conductor (11).

7. The outdoor bushing (1) as claimed in claim 1,
characterized by
at least one drive shaft (24, 28) for the purpose of introducing a drive movement into the switch disconnector (4), each drive shaft (24, 28) being mounted in the fixing means (12, 13).

8. The outdoor bushing (I) as claimed in claim 1,
characterized by
an isolating rocker (14) made from an insulating material for the purpose of introducing a drive movement into the switch disconnector (4).

9. The outdoor bushing (1) as claimed in claim 1,
characterized by
a grounding switch (26).

10. The outdoor bushing (1) as claimed in claim 1, characterized by
the fixing means (12, 13) have an intermediate housing (12) which delimits an intermediate cavity (16) extending a cavity (3) of the insulator (2).

11. The outdoor bushing (1) as claimed in claim 10,
wherein the intermediate housing (13) has an angled housing (31) having a curved profile.

12. The outdoor bushing (1) as claimed in claim 1,
characterized by a current transformer (20) which is at ground potential on the secondary side.

13. The outdoor bushing (1) as claimed in claim 1,
characterized by the fixing means are electrically connected to field control elements (19) for the purpose of avoiding partial discharges.

14. The outdoor bushing (1) as claimed in claim 1, characterized by a display element for the purpose of displaying the position of the switch disconnector (4).

15. The outdoor bushing (1) as claimed in claim 1,
characterized by
at least one drive unit (29), which is supported on the fixing means, for the purpose of producing a drive movement.
